(19) United States
(12) Patent Application Publication
(10) Pub. No.: US 2024/0279884 A1
(43) Pub. Date: Aug. 22, 2024

(54) AN ELECTRIC COMPACTOR WITH BATTERY SYSTEM REDUNDANCY

(71) Applicant: HUSQVARNA AB, Huskvarna (SE)

(72) Inventors: Ivaylo Ivanov, Ruse (BE); Anton Grozev, Ruse (BE); Svetozar Nikolov, Ruse (BE)

(21) Appl. No.: 18/569,089

(22) PCT Filed: May 19, 2022
(86) PCT No.: PCT/SE2022/050496

§ 371 Date: Dec. 11, 2023

(30) Foreign Application Priority Data
Jun. 14, 2021 (SE) 2150758-7
Jun. 14, 2021 (SE) 2150759-5

(51) Int. Cl. E01C 19/40; E01C 21/00; E02D 3/074; H02K 7/06

(52) U.S. Cl. CPC E01C 19/402; E01C 21/00; E02D 3/074; H02K 7/061

(57) ABSTRACT

A ground compactor for ground compaction during construction work, the ground compactor comprising an upper mass movably connected to a lower mass, where the lower mass is arranged to make contact with the ground during compaction, the ground compactor comprising at least one electric motor arranged to operate in a voltage range to drive the ground compactor, the ground compactor further comprising first and second battery compartments for receiving respective first and second batteries, and power circuitry configured to supply power in the voltage range to the at least one electric motor from either of the first and second batteries.

### TECHNICAL FIELD

The present disclosure relates to electrically powered ground compactors for use in construction work, such as plate compactors and rammers.

### BACKGROUND

Good compaction is the foundation of any construction project. It increases bearing capacity and durability and prevents soil settlement and damage through frost and water erosion. Different machines for ground compaction are known, such as drum rollers, rammers, and vibratory plate compactors.

These compaction machines have traditionally been powered by combustion engines, but electric machines are now being introduced to the market. For instance, U.S. Pat. No. 10,344,439 B2 discloses an example of an electrically powered plate compactor. EP 1267001 B1 discloses another example of an electrically powered plate compactor, and U.S. Pat. No. 9,175,447 B2 shows an electrically powered rammer.

It is important that ground compaction machines are well balanced and have capacity for prolonged periods of operation. It is also important that machine handling does not involve any time-consuming maintenance tasks, and that the compactor is easy to use in an efficient manner.

There is a need for improvements in existing electrically powered compactors in order to realize their full potential.

### SUMMARY

It is an object of the present disclosure to provide improved electric ground compactors which are easy to use, and which are able to operate for extended periods of time.

This object is at least in part obtained by an electrically powered ground compactor for ground compaction during construction work. The ground compactor comprises an upper mass movably connected to a lower mass, where the lower mass is arranged to make contact with the ground during compaction. The ground compactor comprises at least one electric motor arranged to operate in a voltage range to drive the ground compactor. The ground compactor further comprises at least first and second battery compartments for receiving respective first and second batteries, and power circuitry configured to supply power in the voltage range to the at least one electric motor from either of the first and second batteries.

Thus, a ground compactor with extended battery capacity is provided. However, instead of a larger battery, this ground compactor comprises two separate batteries which can be used independently from each other, i.e., it is sufficient that one battery is inserted into a battery compartment in order to operate the ground compactor. This simplifies handling because each battery is of reasonable weight. A battery can also be removed from its compartment, e.g., for charging, and the ground compactor can be run from a single battery in the mean-time. This way an operator can maintain the ground compaction operation even during charging of one of the batteries.

According to aspects, the electric motor has a mass center which lies in a first plane, where respective geometric centers of the battery compartments are separated from each other by the first plane. This way the motor is situated in-between the battery compartments, which provides an increased stability to the ground compactor, and also simplifies routing of the electric harness. Advantageously, each battery is separately connected to the drive circuit of the electric motor, such that the ground compactor can be operated as long as at least one battery is inserted into a battery compartment.

According to aspects, the electric motor is arranged for continuous operation during removal and/or insertion of one of the first and the second battery, conditioned on that the other of the first and the second battery is received in its respective battery compartment and has a minimum charge level. This means that the ground compactor implements a “hot swap” feature, where an operator can insert and remove batteries during ground compaction, which is an advantage in some operation scenarios. Advantageously, the motor drive circuit draws power from one battery at a time, which means that one battery becomes depleted at a time and can be charged while the other battery remains fully charged.

According to aspects, the electric motor is arranged to drive an eccentric weight mechanism comprised in the lower mass via a drive belt. These mechanisms are well-tested and provide a reliable means for driving a ground compactor.

According to aspects, the first and second battery compartments are integrally formed in a battery housing, where the battery housing is assembled in the upper mass via at least one vibration isolating element. This way the batteries are better protected from the outside environment, and in particular from the potentially damaging vibrations generated during ground compaction.

According to aspects, the battery housing comprises first, and second battery compartment lids arranged to cover the first and the second battery compartment, respectively. These lids provide additional protection from the outside environment. The lids may comprise locks that prevent opening of the lids. This way the batteries inserted into the battery compartments can be protected from theft. The lock may be realized as a code-lock or an electronic lock, not requiring a physical key.

According to aspects, the battery housing comprises a control panel arranged accessible by an operator to control at least part of the power circuitry. The control panel may advantageously be positioned between the first and second battery compartment lids. This control panel forms part of the control unit 160. The control panel may advantageously be arranged to control locks on the battery compartment lids.

According to aspects, a fan is mounted on the axle of the electric motor, so as to be driven by the motor, and arranged to provide a flow of cooling air into the first and second battery compartments. The flow of cooling air is optionally configured to initially extend from an air intake along an extension direction of the motor axle, followed by a branching of the flow radially out from the motor axle towards the first and the second battery compartment. It is an advantage that the same fan can be used to cool both batteries during use.

The fan may be of varying type, although a radial fan as illustrated in FIG. 3 and in FIG. 4 is preferred. This radial fan may be advantageously configured to also provide a flow of cooling air for cooling the electric motor.

According to aspects, the ground compactor comprises a bottom plate arranged to contact the ground, an engine plate assembled on the bottom plate by a first set of vibrationally isolating elements, and a battery plate assembled on the engine plate by a second set of vibrationally isolating elements, where the electric motor is mounted onto the engine plate and where the battery plate is arranged to support the first and second battery compartments. The two sets of vibrationally isolating elements together provide a sufficient vibration isolation that protects the batteries from the vibration generated during use of the ground compactor. The two sets of vibrationally isolating elements cooperate to achieve this high level of vibration isolation. A further advantage of having two sets of vibration isolating elements is that oscillating behavior by the two masses is suppressed.

Generally, all terms used in the claims are to be interpreted according to their ordinary meaning in the technical field, unless explicitly defined otherwise herein. All references to “a/an/the element, apparatus, component, means, step, etc.” are to be interpreted openly as referring to at least one instance of the element, apparatus, component, means, step, etc., unless explicitly stated otherwise. The steps of any method disclosed herein do not have to be performed in the exact order disclosed, unless explicitly stated. Further features of, and advantages with, the present invention will become apparent when studying the appended claims and the following description. The skilled person realizes that different features of the present invention may be combined to create embodiments other than those described in the following, without departing from the scope of the present invention.

### BRIEF DESCRIPTION OF THE DRAWINGS

The present disclosure will now be described in more detail with reference to the appended drawings, where

FIG. 1 shows an electrically powered plate compactor;

FIG. 2 schematically illustrates relative locations of compactor components;

FIG. 3 shows details of an example battery compactor;

FIG. 4 shows a top view of a compactor battery system;

FIG. 5 is an exploded view of an electrically powered plate compactor;

FIG. 6 shows an example rammer for ground compaction; and

FIG. 7 schematically illustrates relative locations of compactor components.

### DETAILED DESCRIPTION

The invention will now be described more fully hereinafter with reference to the accompanying drawings, in which certain aspects of the invention are shown. This invention may, however, be embodied in many different forms and should not be construed as limited to the embodiments and aspects set forth herein; rather, these embodiments are provided by way of example so that this disclosure will be thorough and complete, and will fully convey the scope of the invention to those skilled in the art. Like numbers refer to like elements throughout the description.

It is to be understood that the present invention is not limited to the embodiments described herein and illustrated in the drawings; rather, the skilled person will recognize that many changes and modifications may be made within the scope of the appended claims.

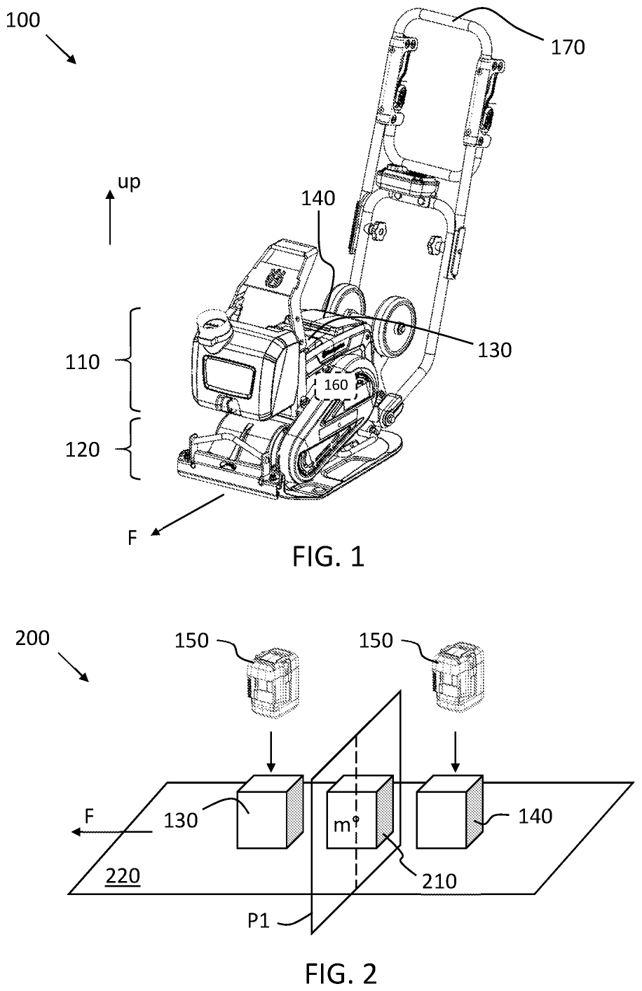

FIG. 1 illustrates an example ground compaction device 100. This particular ground compaction device is normally referred to as a plate compactor. Another example ground compaction device 600, often referred to as a rammer, is shown in FIG. 6. At least some of the technical solutions discussed herein are applicable with both types of compactors.

A ground compactor is used to prepare the ground in preparation for various types of construction work, such as construction of buildings and laying of pipelines and roads. Compactors such as the example plate compactor 100 in FIG. 1 and the example rammer 600 in FIG. 6 have traditionally been powered by gasoline engines. In this case the operator fuels the compactor by filling a gas tank on the machine and may then operate the machine for a relatively long period of time until the gas tank must be refilled once more. The machine normally does not need to be stopped during re-fueling, which may be a particular advantage if compacting sticky materials which may otherwise adhere to the bottom plate which contacts the ground.

The ground compactors 100, 600 optionally comprise control units 160 arranged to control various functions of the ground compactor. The control unit 160 may be connected to a control panel or be comprised as part of a control panel of the ground compactor.

Electrically powered compactors, such as the example provided in U.S. Pat. No. 10,344,439 B2, instead use electrical power to drive the machine. A drawback with electrically powered machines is that the batteries are in need of regular re-charging. Therefore, large batteries are often used in order to provide the endurance required for extended duration operation. However, such large batteries tend to be heavy and cumbersome to handle and may not easily be transportable. Battery charging requires an external power source which is not often conveniently accessible directly from the work location, which means that the batteries need to be transported from the machine at the work location to the location of a charging device. This becomes an issue if the batteries are very heavy.

The present disclosure relates to a compactor with capability to operate for an extended time duration where the battery handling has been made more convenient. This has been achieved by providing two battery compartments for receiving respective batteries of the same type. The machine can be driven from either of these batteries, which means that an operator can remove one battery for charging, and still operate the machine using the remaining battery. By providing two batteries, an extended operating time is obtained. However, each battery is associated with a manageable weight and form factor, allowing convenient manual handling by an operator. An operator wanting to perform a smaller work task only needs one of the batteries.

With reference to FIG. 1 and FIG. 6, there is disclosed herein an electrically powered ground compactor 100, 600 for ground compaction during construction work. The ground compactor comprises an upper mass 110 movably connected to a lower mass 120 arranged below the upper mass 110 when the machine is in use, i.e., closer to the ground. The lower mass 120 is arranged to make contact with the ground during compaction. For the plate compactor, the lower mass may, e.g., comprise the bottom plate and the vibration element, while for the rammer 600, the lower mass comprises the tamping foot.

The compactors 100, 600 are associated with respective forward directions F, where the forward direction is the direction in which the machine normally moves during use. An upwards direction on the machine is herein to be construed as the direction away from ground during use, as indicated in FIG. 1 and FIG. 6. Likewise, a downward direction of the machine is opposite to the upwards direction. During normal operation, an operator is located behind the machine to hold the handle 170, and pushes the machine in the forward direction F.

The ground compactor 100, 600 comprises at least one electric motor 210 arranged to operate in a voltage range to drive the ground compactor 100, 600. Normally, the batteries and electric motor are assembled in the upper mass to protect them from vibration, although there are examples where, e.g., the electric motor is assembled in the lower mass.

The ground compactor 100, 600 further comprises first and second battery compartments 130, 140 for receiving respective first and second batteries 150, and power circuitry configured to supply power in the voltage range to the at least one electric motor 210 from either of the first and second batteries 150. Thus, since the power circuitry is configured to draw power from either of the batteries during operation, an operator can load one or both battery compartments with charged batteries. If batteries are inserted into both battery compartments, then the machine operation time is extended. For shorter duration work tasks, or if only one charged battery is available, then a single battery can be used in one of the battery compartments, leaving the other empty or occupied by a depleted battery. Due to that the battery capacity is split in two in this manner, each battery is manageable in terms of weight and form factor and can therefore be conveniently carried by the operator to the work location.

According to an example, the energy storage capacity of each battery is between 8-12 Ah, and preferably about 9.4 Ah. The nominal voltage of a battery is preferably on the order of 36V, although other voltages can also be conceivable. The weight of this type of battery may be on the order of 1-3 kg, and commonly about 1.9 kg. This type of battery is easily handled manually, i.e., can be carried by an operator from a charging station to the ground compactor at the work site without much difficulty. A battery twice as heavy on the other hand, would be more cumbersome to handle.

According to another example, each battery may be configured to have a weight between 2500 g and 5500 g, and preferably either 3000 g or 5100 g.

With a battery capacity of 9.4 Ah, the working time is on the order of 22 minutes, which means that a ground compactor with two fully charged batteries can be operated for about 44 minutes without interruption. This time span is enough to complete many tasks on a construction site. However, advantageously, one of the batteries can be removed and placed in a charging station while the ground compactor is operated, thus allowing for a considerable extension of the operating time if the batteries are cycled between the charging station and the ground compactor. Indeed, three batteries may be used, where one battery is always in the charging station, while the other two are inserted into the battery compartments. The battery switch can be performed while the ground compactor is in use thanks to the dual battery compartment system disclosed herein.

According to aspects, the electric motor and its associated power circuitry are arranged for continuous operation during removal and/or insertion of one of the first and the second battery, conditioned on that the other of the first and the second battery is received in its respective battery compartment and has a minimum charge level. This feature may be referred to as a hot-swap feature where the operator can replace batteries without first stopping the machine. The possibility for hot-swap of a charged battery with an empty battery may be particularly advantageous while compacting sticky materials where the compactor may get stuck if stopped for too long, or more sensitive materials where the compactor may leave a mark if left at one place for too long.

The batteries are optionally connected separately to the motor drive circuitry. This means that each battery compartment has its own separate connectors that are wired to the drive circuit. The drive circuit is then in a position to select which battery to draw power from. In some cases it may be preferable to only draw power from one of the batteries, such that only one battery becomes depleted. This is an advantage, since the depleted battery can then be transported away to a charging station, and the ground compaction operation can be continued with power from the other battery. Thus, according to some aspects, the ground compactor comprises power circuitry configured to select an active battery compartment out of the first and the second battery compartments, and to draw power from a battery inserted into the active battery compartment during use, conditioned on that a battery is inserted into the active battery compartment and that this battery has a sufficient level of charge. When the active compartment battery becomes depleted or is removed from the battery compartment, then the power circuitry is configured to switch active battery compartment to the other battery compartment. In case no battery of sufficient charge is inserted into any of the compartments, then the power circuitry is configured to inactivate the ground compactor.

A control panel may be arranged to indicate to an operator which battery compartment that is the active battery compartment, and which battery compartment that is the inactive battery compartment. This allows the operator to remove the battery from the inactive battery compartment in a convenient manner.

According to further aspects, the motor drive circuitry may comprise an input port for receiving a signal that determines which battery compartment that is the active battery compartment. This way the operator may override the selection of active battery compartment to manually select which battery that should be used to power the ground compactor. This signal may, e.g., be generated from a control panel of the ground compactor.

According to an option, the ground compactor may also be arranged to indicate when the active battery compartment changes, such that an operator receives a notification that one battery has become depleted. This notification may be a visual signal, such as a flashing light, and/or an audible signal such as a buzzer sound or the like.

According to further aspects, the power circuitry, or a control unit on the ground compactor, may be arranged to switch active battery compartment in case of the batteries risk overheating. This way the motor drive circuitry may cycle back and forth between batteries, such that no battery becomes over-heated. The battery not used for driving the ground compactor will still receive the flow of cooling air discussed in more detail below in connection to FIG. 4.

To summarize, the ground compactor 100, 600 optionally comprises a control unit 160 arranged to select an active battery compartment out of the first and the second battery compartments 130, 140 for driving the electric motor 210, where the selection of the active battery compartment is based on any of: presence of a battery in one or both battery compartments, a state of charge of inserted batteries, a temperature of inserted batteries, and/or a manual selection of active battery compartment.

The ground compactor may optionally comprise a third energy source separate from both battery compartments. This third energy source may be configured to power control circuitry and user interface of the ground compactor. This feature allows for interacting with an operator even if no battery is inserted into a battery compartment. The third energy source may optionally be arranged as a rechargeable battery and re-charged from a battery inserted into one of the battery compartments.

As mentioned above, stability is important in a compactor. To provide an even distribution of weight, with reference to FIG. 2, the electric motor 210 can be configured with a mass center m which lies in a first plane P1, and respective geometric centers of the battery compartments 130, 140 can be configured separated from each other by the first plane P1. In other words, the electric motor 210 can be assembled in-between the two battery compartments. This mass distribution also makes it easier to isolate the energy storage system from vibration, e.g., by mounting the battery compartments on a carrier plate 220 which then can be assembled to the rest of the structure via vibration isolating elements, such as rubber elements or other forms of dampers.

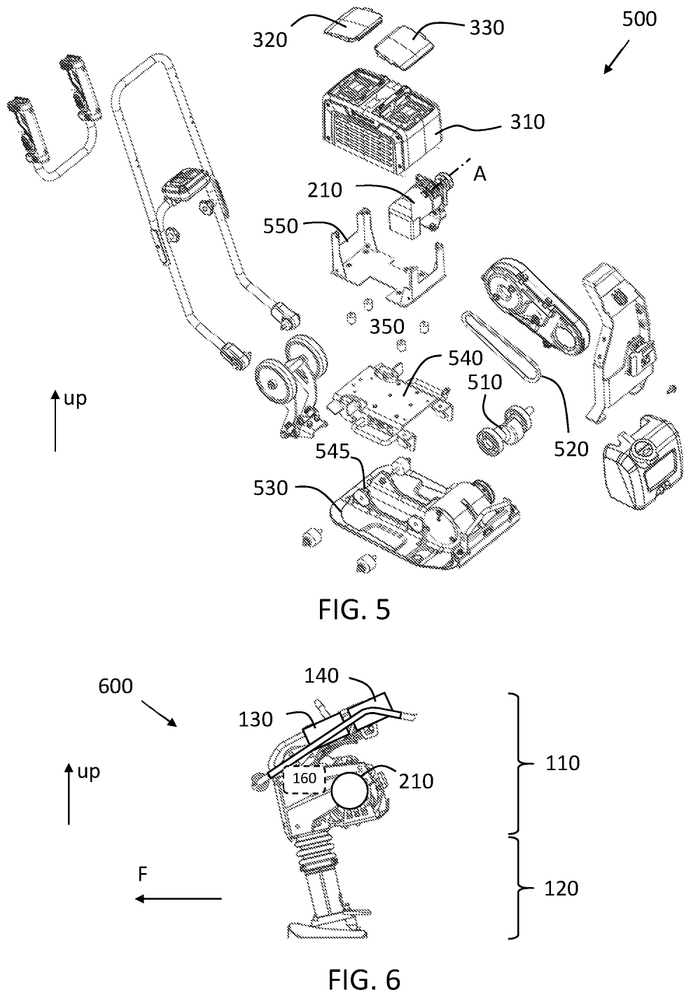

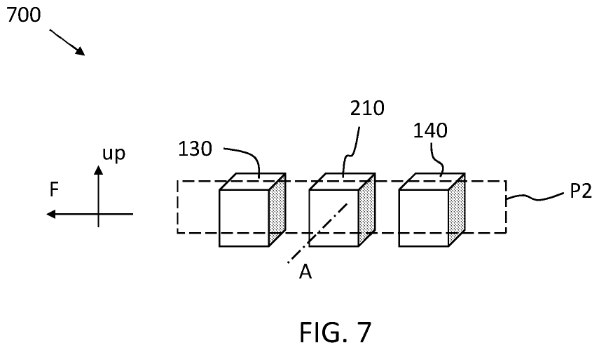

For example, with reference also to FIG. 5 and FIG. 7, the first plane P1 can be aligned with a motor axle A of the electric motor, such that the two battery compartments 130, 140 are arranged on either side of the motor axle A. In other words, the motor axle A of the electric motor 210 can be configured in parallel to the first plane P1. Also, a forward direction F of the ground compactor 100 can be configured normal to the first plane P1. This means that the batteries are arranged on a longitudinal axis of the compactor, which is an advantage since they can be better protected from mechanical impacts and the like when arranged in this manner. For instance, a protective frame or other structure can be arranged to enclose the two battery compartments, thereby providing an increased mechanical integrity to the design. The first plane P1 can according to some aspects be perpendicular to the forward direction F. The first plane P1 can according to some aspects run parallel to the motor axle A, but not needing to be aligned with the motor axle A.

According to some aspects, as shown in FIG. 5, the motor axle A has an extension that according to some aspects runs essentially parallel to a main extension of an engine plate 540 to which the electric motor 210 is mounted.

FIG. 7 shows a preferred geometric arrangement 700 of the battery compartments 130, 140 and the motor 210. The electric motor 210 has a motor axle (indicated as A) arranged to drive the ground compactor 100, e.g., via an excentre element. A second plane P2 perpendicular to the extension direction of the motor axle A intersects the first and second battery compartments 130, 140, and the electric motor 210. This means that the two battery compartments and the motor are aligned in the longitudinal extension direction of the compactor, i.e., are mounted one after the other in the forward direction F. The battery compartments and the motor are preferably interleaved, such that the motor 210 is located in-between the first and the second battery compartment as shown in FIG. 7.

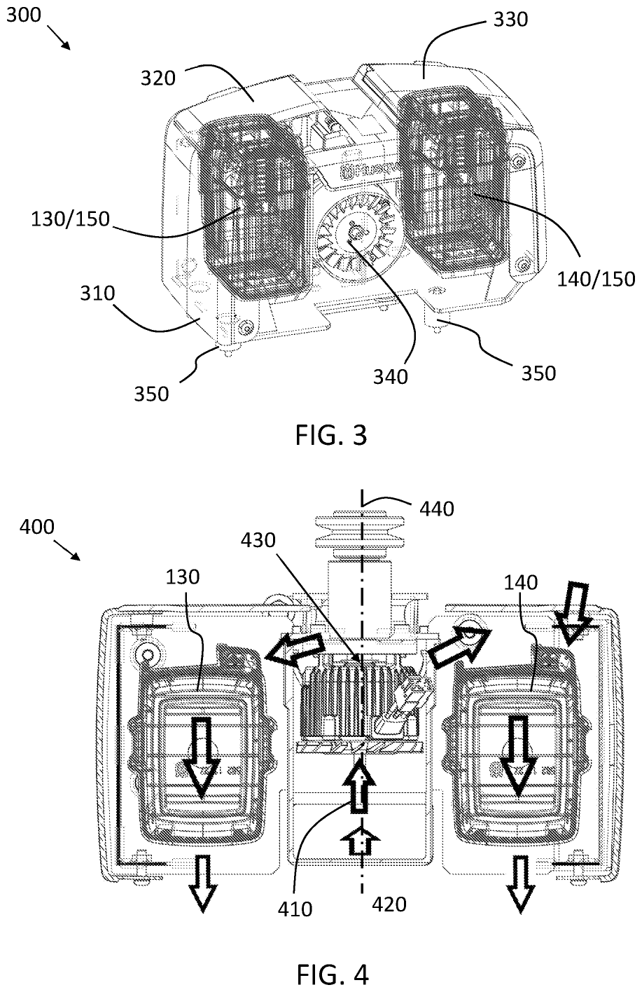

FIG. 3 illustrates details 300 of the plate compactor 100. In particular, a battery housing 310 is illustrated into which the first and second battery compartments 130, 140 are integrally formed. The battery housing 310 is preferably assembled in the upper mass 110 of the plate compactor 100 via at least one vibration isolating element 350. The battery housing provides protection for the two batteries, and in particular prevents dirt and moisture from entering into the electrical connections to the first and second batteries.

As shown in FIG. 3, the battery housing 310 may also comprise first and second battery compartment lids 320, 330 arranged to cover the first and the second battery compartment 130, 140, respectively. Optionally, the lids can comprise gaskets to provide a water-tight seal around the lid. The lids may be configured with locks in order to prevent theft of a battery inserted into the battery compartment. The locks may be mechanical locks or electronic locks. The compartment lids 320, 330 are not necessary, and the batteries 150 may be arranged in the battery compartments 130, 140 without lids or any other types of cover.

The battery housing 310 optionally comprises a control panel (not shown in FIG. 3) arranged accessible by an operator to control at least part of the power circuitry. This control panel can advantageously be arranged between the first and second battery compartment lids 320, 330, where it is protected from mechanical impacts and the like during operation. It is an advantage to provide a control panel on a housing such as that illustrated in FIG. 3, since the electric motor and the batteries are close by, which reduces the need for cabling.

If the lids comprise electronic locks, then the control panel can be configured to control these locks, e.g., by requesting the operator to input a code in order to allow a battery to be removed from its compartment.

The control panel may also be arranged to indicate which battery compartment that is currently being used to provide power to the motor, such that an operator may remove the non-active battery from its compartment.

The control panel may also be arranged to indicate respective states of charge for batteries inserted into the battery compartments. This way the operator can determine which battery that is in need of charging and remove this battery for transportation away to the charging station.

With reference also to FIG. 4, FIG. 3 also shows a fan 340 arranged on the motor axle of the electric motor 210. The fan 340 is arranged to provide a flow of cooling air 410 into the first and second battery compartments 130, 140. This flow of cooling air 410 initially extends from an air intake 420 along an extension direction 440 of the motor axle, followed by a branching of the flow 430 radially out from the motor axle towards the first and the second battery compartment 130, 140.

Since cooling air 410 is guided towards the first and second battery compartments 130, 140 via the electric motor 210, the cooling air 410 can be slightly warmed up when passing the electric motor 210. This is an advantage when working at relatively low temperatures since battery capacity normally increases with temperature. This is also advantageous since if both batteries 150 are mounted in the battery compartments 130, 140, but only one battery is used to power the electric motor 210, the other battery is maintained at a suitable working temperature by means of the cooling air 410 and ready for use.

According to some aspects, cooling air 410 is also guided towards the control panel and associated control units 160 via separate guiding means (not shown). A cooling flange may be attached to the control unit 160.

FIG. 5 shows an exploded view 500 of the example compactor 100. The plate compactor comprises an electric motor 210 arranged to drive an eccentric weight mechanism 510 comprised in the lower mass 120 via a drive belt 520. According to some aspects, the drive belt 520 is a Poly V-belt, which reduces friction losses and thus increases battery running time. It is also conceivable to position the electric motor 210 such that it can drive the eccentric weight mechanism 510 directly, without needing a belt.

The ground compactor 100 comprises a bottom plate 530 arranged to contact the ground, an engine plate 540 assembled on the bottom plate 530 by a first set of vibrationally isolating elements 545, and a battery plate 550 assembled on the engine plate 540 by a second set of vibrationally isolating elements 350, where the electric motor is mounted onto the engine plate 540 and where the battery plate is arranged to support the first and second battery compartments 130, 140. Notably, the plate 540 is referred to here as “engine plate” even though an electric machine and no combustion engine is mounted thereon. This way a particularly efficient vibration isolation is achieved, since vibration from the ground must traverse two sets of vibration isolating elements 545, 350 before reaching the battery compartments. The first set of vibration isolating elements protect the electric motor from vibration, and indirectly also the batteries. However, the other set of vibrationally isolating elements provide further vibration isolation, and thus increase the vibration protection of the batteries. Having two sets of vibration isolating elements in this manner also reduces oscillation between the battery compartment and the motor, which is an advantage.

According to some aspects, air is guided from the engine plate 540 to the battery plate 550 via one or more flexible air guiding means such as rubber channels, such that movements between the engine plate 540 and the battery plate 550 that occur due to the second set of vibrationally isolating elements 350 can be handled.

According to some aspects, the battery compartments 130, 140 comprise electrical connectors that are adapted to engage and contact corresponding electrical connectors comprised in the batteries 150 when the batteries 150 are inserted into a respective battery compartment 130, 140.

According to some aspects, the battery compartments 130, 140 are mutually separate. According to some aspects, the battery compartments 130, 140 do not have to be completely separate from each other, but each battery compartment 130, 140 is formed to receive one respective battery 155.

1. An electrically powered ground compactor for ground compaction during construction work,
the ground compactor comprising an upper mass movably connected to a lower mass, wherein the lower mass is arranged to make contact with the ground during compaction,
the ground compactor comprising an electric motor arranged to operate in a voltage range to drive the ground compactor,
the ground compactor further comprising a first battery compartment and a second battery compartments for receiving a first battery and a second battery, respectively, and power circuitry configured to supply power in the voltage range to the electric motor from either of the first and second batteries.

2. The ground compactor according to claim 1, wherein the electric motor has a mass center which lies in a first plane, wherein respective geometric centers of the first and second battery compartments are separated from each other by the first plane.

3. The ground compactor according to claim 2, wherein a motor axle of the electric motor is parallel to the first plane.

4. The ground compactor according to claim 2, wherein a forward direction of the ground compactor is normal to the first plane.

5. The ground compactor according to claim 1, wherein the electric motor is arranged for continuous operation during removal or insertion of one of the first and the second battery, conditioned on that the other of the first and the second battery is received in its respective battery compartment and has a minimum charge level.

6. The ground compactor according to claim 1, wherein the electric motor is arranged to drive an eccentric weight mechanism comprised in the lower mass via a drive belt.

7. The ground compactor according to claim 1, wherein the first and second battery compartments are integrally formed in a battery housing, wherein the battery housing is assembled in the upper mass via at least one vibration isolating element.

8. The ground compactor according to claim 7, wherein the electric motor is at least partly enclosed by the battery housing.

9. The ground compactor according to claim 7, wherein the battery housing comprises first and second battery compartment lids arranged to cover the first and the second battery compartment, respectively.

10. The ground compactor according to claim 9, wherein the battery housing comprises a control panel arranged accessible by an operator to control at least part of the power circuitry.

11. The ground compactor according to claim 10, wherein the control panel is arranged between the first and second battery compartment lids.

12. The ground compactor according to claim 1, wherein a fan is mounted on an axle of the electric motor and arranged to provide a flow of cooling air into the first and second battery compartments.

13. The ground compactor according to claim 12, wherein the fan is a radial fan, and wherein the ground compactor is a plate compactor or a rammer.

14. The ground compactor according to claim 12, wherein the flow of cooling air initially extends from an air intake along an extension direction of the motor axle, followed by a branching of the flow radially out from the motor axle towards the first and the second battery compartment.

15. The ground compactor according to claim 1, comprising a bottom plate arranged to contact the ground, an engine plate assembled on the bottom plate by a first set of vibrationally isolating elements, and a battery plate assembled on the engine plate by a second set of vibrationally isolating elements, wherein the electric motor is mounted onto the engine plate and wherein the battery plate is arranged to support the first and second battery compartments.

16. (canceled)

17. The ground compactor according to claim 1, comprising a control unit arranged to select an active battery compartment out of the first and the second battery compartments for driving the electric motor, wherein the selection of the active battery compartment is based on any of: presence of a battery in one or both battery compartments, a state of charge of inserted batteries, a temperature of inserted batteries, a manual selection of active battery compartment.

18. An electrically powered ground compactor for ground compaction during construction work,
the ground compactor comprising an upper mass movably connected to a lower mass, wherein the lower mass is arranged to make contact with the ground during compaction,
the ground compactor comprising at least one electric motor with a motor axle arranged to drive the ground compactor,
the ground compactor further comprising first and second battery compartments for receiving respective first and second batteries,
wherein a second plane perpendicular to an extension direction of the motor axle intersects the first and second battery compartments, and the electric motor.

19. The ground compactor according to claim 18, wherein the electric motor has a mass center which lies in a first plane, wherein respective geometric centers of the battery compartments are separated from each other by the first plane,
wherein the first and second battery compartments are integrally formed in a battery housing, wherein the battery housing is assembled in the upper mass via at least one vibration isolating element,
wherein the electric motor is at least partly enclosed by the battery housing,
wherein the battery housing comprises first and second battery compartment lids arranged to cover the first and the second battery compartment, respectively, and
wherein the battery housing comprises a control panel arranged accessible by an operator to control at least part of a power circuitry of the ground compactor.

20-23. (canceled)

24. The ground compactor according to claim 18, wherein a radial fan is mounted on an axle of the electric motor and arranged to provide a flow of cooling air into the first and second battery compartments,
wherein the fan is arranged to provide a flow of cooling air for cooling the electric motor, and
wherein the flow of cooling air initially extends from an air intake along an extension direction of the motor axle, followed by a branching of the flow radially out from the motor axle towards the first and the second battery compartment.

25-27. (canceled)

28. The ground compactor according to claim 18, wherein the electric motor is arranged for continuous operation during removal and/or insertion of one of the first and the second battery, conditioned on that the other of the first and the second battery is received in its respective battery compartment and has a minimum charge level.
